(19) United States
(12) Patent Application Publication
(10) Pub. No.: US 2026/0160300 A1
(43) Pub. Date: Jun. 11, 2026

(54) ROTARY BEARING FOR A CEILING MOUNT

(71) Applicant: Schaeffler Technologies AG & Co. KG, Herzogenaurach (DE)

(72) Inventors: Patrick Daniel, Kirkel (DE); Dietmar Rudy, Kleinbundenbach (DE); Arsene Herrmann, Oermingen (FR)

(73) Assignee: Schaeffler Technologies AG & Co. KG, Herzogenaurach (DE)

(21) Appl. No.: 18/851,960

(22) PCT Filed: Feb. 28, 2023
(86) PCT No.: PCT/DE2023/100158

§ 371 Date: Sep. 27, 2024

(30) Foreign Application Priority Data
Mar. 28, 2022 (DE) 10 2022 107 259.2

(51) Int. Cl. F16C 35/02

(52) U.S. Cl. CPC F16C 35/02

(57) ABSTRACT

A rotary bearing for a ceiling mount includes a housing, a shaft which can be rotated about a longitudinal axis and which can be rotated in an adjustable rotational range relative to the housing, a housing-side first stop, and at least a shaft-side second stop. The first stop strikes the at least one second stop at the end positions of the rotational range. The second stop being adjustable in the circumferential direction about the shaft in order to configure the rotational range and being arranged in a securable manner on the shaft side. The at least one second stop is designed as a sliding block, is movably arranged in the circumferential direction in a shaft-side clamping groove, and is releasably clamped on the shaft side by means of clamping means.

### CROSS-REFERENCE TO RELATED APPLICATIONS

This application is the U.S. National Phase of PCT Appln. No. PCT/DE2023/100158 filed Feb. 28, 2023, which claims priority to DE 10 2022 107 259.2 filed Mar. 28, 2022, the entire disclosures of which are incorporated by reference herein.

### TECHNICAL FIELD

The present disclosure relates to a rotary bearing for a ceiling mount. Such ceiling mounts on the ceilings of rooms are preferably used in the medical field. With the help of these rotary bearings, swivel arms can be rotatably mounted on the ceiling of a room and can carry medical equipment at the end facing away from the ceiling.

### BACKGROUND

In many cases, it is desired to limit the swivel range of the swivel arms and thus also of the rotary bearing. EP 3168520 B1 discloses a rotary bearing for a ceiling mount.

It has a housing on a shaft which can be rotated about a longitudinal axis, which can be rotated in an adjustable rotational range relative to the housing, with a housing-side first stop (119) and two shaft-side second stops 120, which are arranged at a distance from one another in the circumferential direction about the longitudinal axis. The first stop hits the second stops in the end positions of the rotational range. The two stops are formed by blocks 120, which can be screwed tightly to the shaft side by means of fastening screws. A plurality of bores are provided on the shaft side to which these blocks can be screwed. Depending on the desired swivel range, two bores are required to secure the blocks.

The shaft-side bores define a grid for positioning the blocks. If a block needs to be moved, the screws must be loosened and the block is moved along the grid. Only swivel ranges that fit into the grid divisions can be set. If these bores are designed as threaded bores, a plurality of threaded bores must be provided.

### SUMMARY

The object of the disclosure was to provide a rotary bearing which is simplified in comparison and enables a desired pivoting range to be set in a simple manner.

According to the disclosure, this object was achieved by the rotary bearing according to the present disclosure. The rotary bearing for a ceiling mount is provided with a housing and a shaft which can be rotated about a longitudinal axis. The housing can be part of the stationary ceiling mount and can, for example, be sleeve-shaped. The shaft arranged in the housing can also be sleeve-shaped and carry one end of a swivel arm of a swivel arm system.

The shaft is arranged to be rotatable or pivotable relative to the housing over an adjustable rotational range. The rotational range is adjustable over a wide range of less than 360 degrees, based on a swivel angle about the longitudinal axis of the shaft.

A first stop is provided on the housing side. This first stop can conveniently be provided by a separate component that is attached, for example screwed, to the housing. One variant is possible with a bayonet lock, the pin of which is accommodated in a housing bore and works together with the second stop. Furthermore, at least one shaft-side second stop is provided, which is freely adjustable in the circumferential direction about the shaft in order to configure the rotational range relative to the shaft and which can be fixed on the shaft side.

Preferably, two second stops are provided, wherein one of the two second stops can be fixed on the shaft side. However, this other second stop can also be freely adjustable. In the case of two shaft-side second stops, these are arranged at a distance from one another in the circumferential direction about the longitudinal axis of the shaft.

The first stop hits the second stops in the end positions of the rotational range. When the swivel arm is swiveled, i.e. the shaft is swiveled relative to the housing, one of the second stops strikes against the stationary first stop in one direction of rotation and the other of the two second stops strikes against the stationary first stop in the opposite direction. The first stop engages between the two second stops in the circumferential direction around the pivot axis of the shaft.

One variant provides that one of the two second stops remains ineffective, so that the swivel range of the shaft is only determined by the one second stop.

The at least one second stop is designed as a sliding block and is movably arranged in the circumferential direction in a shaft-side clamping groove and is releasably clamped on the shaft side by means of clamping means. In this way, a continuous adjustment of the rotational range for the shaft is possible. The sliding blocks can be inserted into the clamping groove before assembling the shaft with the housing. To clamp the sliding block, the sliding block can contain clamping means that are operated by means of a tool in order to spread the sliding block in the clamping groove so far that it is frictionally fixed in the clamping groove.

The clamping groove can be opened towards the first stop—preferably by a slot—and provided with an undercut which the sliding block overlaps, wherein the clamping means can be pressed against a groove base of the clamping groove arranged around the longitudinal axis, wherein the sliding block is supported on the undercut of the clamping groove opposite the groove base. In this sense, the sliding block nut can be spread out to clamp it in the clamping groove.

The clamping groove can have a circumferentially continuously open slot in the rotational range of the rotary bearing, into which the first stop and the second stop engage. This design is useful when the shaft is cylindrical and is inserted into the housing, which has a hollow cylindrical receptacle for the shaft. A first stop arranged on the inner circumference of the hollow cylindrical receptacle can project radially inwards and engage in the slot, which can be circumferentially limited by the two second stops.

The slot begins at the outer circumference of the clamping groove and extends to the groove base of the clamping groove.

The clamping means can comprise a clamping screw which is screwed into a threaded bore of the sliding block and can be actuated from the outside through a through-hole. For example, if the shaft is inserted into the hollow cylindrical receptacle in the manner described and the housing-side through-hole is set at the level of the shaft-side slot, a pin-shaped tool can be passed through the housing opening from the outside and brought into engagement with the clamping screw. The screw can have a hexagon socket and the tool can be a suitable hexagon socket spanner.

The through-hole can be designed for receiving the first stop. In this case, the through-hole has a dual function: on the one hand it serves as a tool feed-through and on the other hand as a receptacle for the first stop. In this case, the through-hole can be designed as a threaded bore and the first stop as a stop screw screwed to the threaded bore.

The shaft can have a first sleeve and a second sleeve arranged coaxially to the first sleeve, which together form the clamping groove for the sliding block. In this, a section of the clamping groove is formed on each of the two clamping sleeves, which can be manufactured in a simple manner. The undercut and the slot are only formed when the two sleeves are put together.

The first sleeve can have an external thread and the second sleeve can have a second thread screwed to the first thread, wherein the first and second sleeves preferably each have a radially projecting annular shoulder on their outer circumference, between which an annular projection formed on the inner circumference of the housing and projecting radially inwards engages, whereby a rolling bearing is arranged between each shoulder and the projection.

The shoulders and the annular projection of which can have conical surfaces arranged coaxially to one another, wherein an angular contact needle bearing is arranged between the conical surface of each shoulder and the conical surface of the annular projection facing this conical surface, wherein a preload of the angular contact needle bearings is adjustable by a screw position of the sleeves screwed together.

The desired preload can be easily adjusted by assembling the rotary bearing: if the housing is roughly tubular, the two rolling bearings can be inserted, one from one axial side of the housing, the other rolling bearing from the opposite axial side of the housing. The inner sleeve can then be inserted from one axial side of the housing and the outer sleeve from the other side; the two sleeves are screwed together in the housing. When the two sleeves are screwed together, the conical surfaces of the two sleeves axially approach the radial annular projection of the housing. The rolling bearings arranged between the projection and the two conical surfaces of the two sleeves are finally adjusted with the desired bearing clearance or preload.

A particularly advantageous rotary bearing enables the change between two preset swivel ranges without changing the position of even one of the sliding blocks. For this purpose, the two second stops are formed by a shorter stop and a longer stop, both of which extend to different distances in the direction of the first stop. The first stop optionally extends in the direction of the second stops to such an extent that the first stop in the direction of the second stops either overlaps both second stops for a positive stop in both directions of rotation or only the longer stop for a positive stop in both directions of rotation.

In the case of the first alternative, the smaller preset swivel range is effective. The first stop can be formed by a stop screw as described above, which is screwed into the housing bore. The stop screw is screwed in until it overlaps both second stops for a positive stop. Both second stops are effective.

In the case of the second alternative, the shorter shaft-side second stop rolls over the first housing-side stop without coming into contact with it. For this purpose, the stop screw is only screwed into the housing bore so deeply that it only overlaps one of the two second stops for a positive stop. If the shaft is now pivoted about the longitudinal axis, the longer second stop strikes against the housing-side stop in the end positions of the pivoting range; in one pivoting direction with one circumferential end, in the other pivoting direction with the other circumferential end. Within this maximum swivel range, the shorter second stop remains ineffective and rolls over the first stop.

The first stop can be formed by two stop screws of different lengths for the optional activation of the two preset swivel ranges; a shorter stop screw for the larger swivel range, a longer stop screw for the smaller swivel range.

In a known manner, the rotary bearing can be provided with a braking device for braking pivoting movements of the shaft relative to the housing. Passive electric brakes are the preferred option.

### BRIEF DESCRIPTION OF THE DRAWINGS

In the following, the disclosure is explained in more detail on the basis of three exemplary embodiments illustrated in a total of five figures. In the drawings:

FIG. 1 shows a spatial representation of a rotary bearing,

FIG. 2 shows an enlarged section of FIG. 1,

FIG. 3 shows a longitudinal section through the rotary bearing,

FIG. 4 shows a detailed enlargement of the rotary bearing from FIG. 2,

FIG. 5 shows a variant of the rotary bearing in a partial section, and

FIG. 6 shows another variant in a partial section.

### DETAILED DESCRIPTION

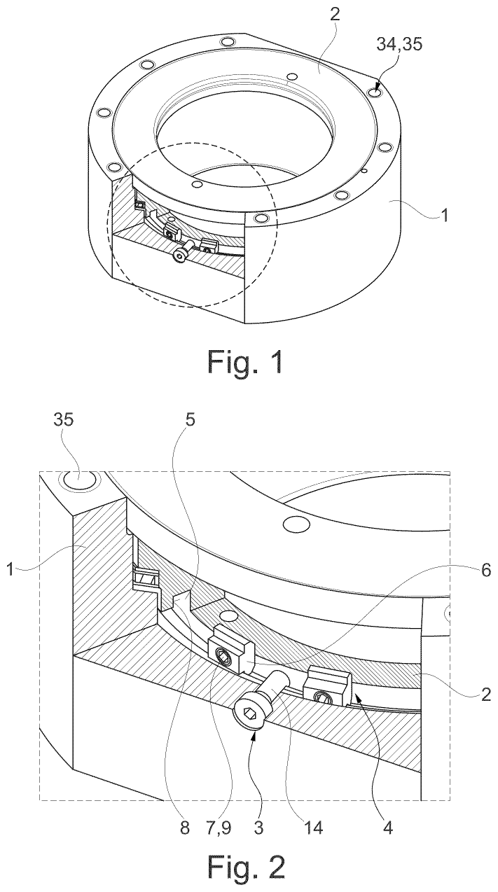

The rotary bearing for a ceiling mount shown in FIGS. 1, 2 and 3 comprises a housing 1 and a shaft 2 which can be rotated about a longitudinal axis and which can be rotated in an adjustable rotational range relative to the housing 1. Furthermore, a housing-side first stop 3 is provided, as well as at least two shaft-side second stops 4, which are arranged at a distance from one another in the circumferential direction about the longitudinal axis. The first stop 3 strikes the second stops 4 at the end positions of the rotational range, at least one of which is arranged so as to be adjustable in the circumferential direction about the shaft 2 in order to configure the rotational range and is arranged in a securable manner on the shaft side.

The shaft 2 is provided on its cylindrical outer circumference with an endless clamping groove 5 curved in a circle about the longitudinal axis, which is arranged in a plane transverse to the longitudinal axis of the shaft 2. Two second stops 4 are each designed as a sliding block 6 and are movably arranged in the clamping groove 5 in the circumferential direction. Each sliding block 6 has a releasable clamping means 7 formed by a clamping screw 9 for clamping to the shaft 2.

The detailed enlargement in FIG. 4 clearly shows the arrangement of the sliding block 6 in the clamping groove 5. The clamping groove 5 is open towards the first stop 3 and is provided with an undercut 8 which overlaps the sliding block 6. The clamping screw 9 is screwed into a threaded bore 12 of the sliding block 6 and is pressed with its screw end 10 against a groove base 11 of the clamping groove 5 arranged about the longitudinal axis. The sliding block 6 is supported on the undercut 8 of the clamping groove 5 opposite the groove base 11. The clamping groove 5 has a circumferentially continuously open slot 16 in the rotational range of the rotary bearing, into which the sliding block 6 engages. The first stop 3 also engages in this slot 16 (FIG. 2).

FIGS. 1 and 2 also show that the housing 1 has a through-hole 13 for receiving the first stop 3, which is formed in the exemplary embodiment by a stop screw 14 which is screwed into a threaded bore 15 forming the through-hole 13. The threaded bore 15 is in the plane in which the clamping screw 9 of the sliding block 6 is located. The clamping screw 9 can be accessed from the outside through the threaded bore 15 of the housing 1. In the exemplary embodiment, an external hexagon socket spanner (not shown) can be passed through the threaded bore 15 and brought into engagement with the screw head of the clamping screw 9 in order to clamp or loosen the sliding block 6.

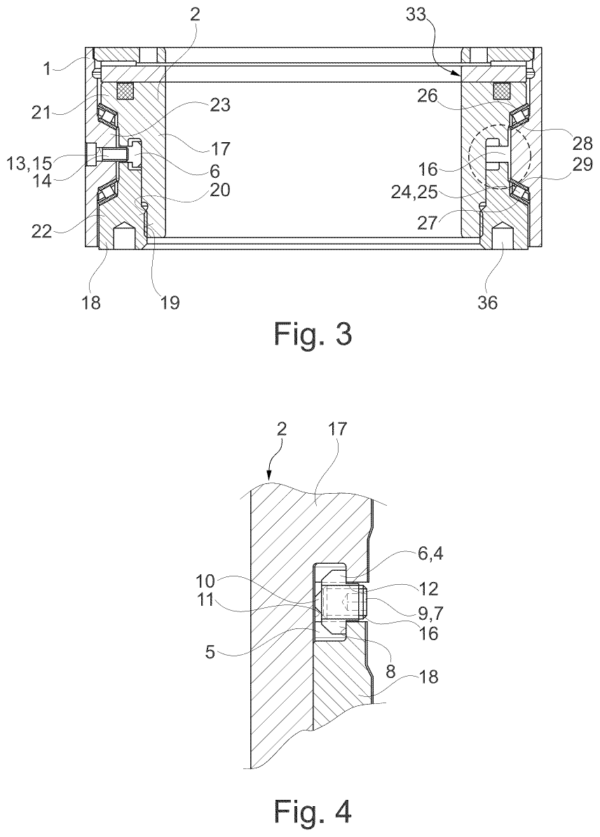

FIG. 3 clearly shows the multi-part structure of the shaft 2, which has a first sleeve 17 and a second sleeve 18 arranged coaxially to the first sleeve 17, which together form the clamping groove 5 for the sliding block 6.

The first hollow cylindrical sleeve 17 has an external thread 19 and the second hollow cylindrical sleeve 18 has an internal thread 20 screwed to the first sleeve 17. The first and second sleeves 17, 18 each have a radially outwardly projecting annular shoulder 21, 22, between which an annular projection 23 formed on the inner circumference of the housing 1 engages, wherein a rolling bearing 24 is arranged between each shoulder 21 and the annular projection 23, which is formed in the exemplary embodiment by an angular contact needle bearing 25.

The shaft-side shoulders 21, 22 and the housing-side annular projection 23 have conical surfaces 26, 27, 28, 29 arranged coaxially to one another, wherein one of the angular contact needle bearings 25 is arranged between the conical surface 26, 27 of each shoulder 21, 22 and the conical surface 28, 29 of the annular projection 23 facing this conical surface 26, 27. A preload or a bearing clearance of the angular contact needle bearings 25 is adjustable by a screw position of the sleeves 17, 18 of the shaft 2 that are screwed together.

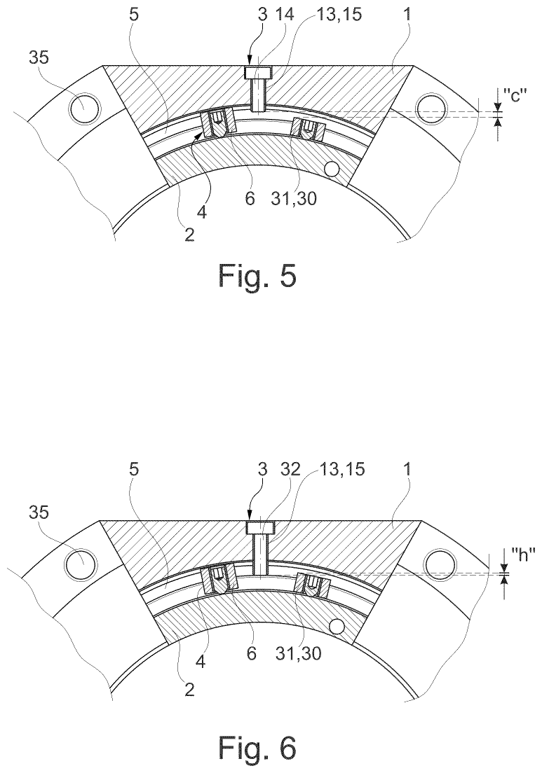

FIG. 5 shows a variant of the described rotary bearing, which differs only by a modified second stop 30. The figure clearly shows the different radial extensions of the two second stops 4, 30 in the direction of the stop screw 14. The second stop 30 is radially shorter than the other second stop 4. The second stop 30 is so short that it can no longer strike the stop screw 14. In the figure, a radial distance “c” is set between the stop screw 14 and the second stop 30. The second stop 30 is designed as a sliding block 31, just as in the previously described embodiment.

FIG. 6 shows another variant of the described rotary bearing, based on the rotary bearing shown in FIG. 4. In the exemplary embodiment according to FIG. 6, only a modified stop screw 32 is provided, which is longer than the stop screw 14. In the figure, a radial overlap “h” is established between the stop screw 32 and the second stop 30. In this way, both stops 6 and 30 are effective in both directions of rotation.

A braking device 33 is inserted between the housing 1 and the shaft 2, which brakes pivoting movements of the shaft 2 relative to the housing 1. This braking device can be omitted and is provided as an option.

The rotary bearing has a housing-side ceiling connection 34, which comprises a plurality of bores 35 in the housing 1 distributed over the circumference. On the shaft side, the rotary bearing also has threaded bores 36 on one end face of the shaft 2 in order to screw a swivel arm (not shown) to the rotary bearing.

List of reference signs

| | |
|---|---|
| 1 | Housing |
| 2 | Shaft |
| 3 | First stop |
| 4 | Second stop |
| 5 | Clamping groove |
| 6 | Sliding block |
| 7 | Clamping means |
| 8 | Undercut |
| 9 | Clamping screw |
| 10 | Screw end |
| 11 | Groove base |
| 12 | Threaded bore |
| 13 | Through-hole |
| 14 | Shorter stop screw |
| 15 | Threaded bore |
| 16 | Slot |
| 17 | First sleeve |
| 18 | Second sleeve |
| 19 | External thread |
| 20 | Internal thread |
| 21 | Shoulder |
| 22 | Shoulder |
| 23 | Projection |
| 24 | Rolling bearing |
| 25 | Angular contact needle bearing |
| 26 | Conical surface |
| 27 | Conical surface |
| 28 | Conical surface |
| 29 | Conical surface |
| 30 | Second stop |
| 31 | Sliding block |
| 32 | Longer stop screw |
| 33 | Braking device |
| 34 | Ceiling connection |
| 35 | Bore |
| 36 | Threaded bore |

1. A rotary bearing for a ceiling mount, comprising: a housing, and a shaft which can be rotated about a longitudinal axis and which can be rotated in an adjustable rotational range relative to the housing, a housing-side first stop, and at least a shaft-side second stop, wherein the first stop strikes the at least one second stop at end positions of the rotational range, said second stop being adjustable in a circumferential direction about the shaft in order to configure the rotational range and being arranged in a securable manner on the shaft side, wherein the at least one second stop is designed as a sliding block and is movably arranged in the circumferential direction in a shaft-side clamping groove and is releasably clamped on the shaft side by means of clamping means.

2. The rotary bearing according to claim 1, wherein the clamping groove is open towards the first stop and is provided with an undercut which overlaps the sliding block, wherein the clamping means are pressed against a groove base of the clamping groove arranged about the longitudinal axis, wherein the sliding block is supported on the undercut of the clamping groove opposite the groove base.

3. The rotary bearing according to claim 1, wherein the clamping groove has a circumferentially continuously open slot in the rotational range of the rotary bearing, into which slot the first stop and the second stop engage.

4. The rotary bearing according to claim 1, wherein the clamping means comprise a clamping screw which is screwed into a threaded bore of the sliding block and can be actuated from an outside through a through-hole.

5. The rotary bearing according to claim 4, wherein the through-hole is designed as a threaded bore and for receiving the first stop, which is designed as a stop screw screwed to the threaded bore.

6. The rotary bearing according to claim 1, comprising two second stops which are arranged one behind the other in the circumferential direction about the longitudinal axis.

7. The rotary bearing according to claim 1, wherein the shaft has a first sleeve and a second sleeve arranged coaxially to the first sleeve, which together form the clamping groove for the sliding block.

8. The rotary bearing according to claim 7, wherein the first sleeve has an external thread and the second sleeve has an internal thread screwed to the external thread, wherein the first and second sleeves each have a radially projecting annular shoulder between which an annular projection formed on an inner circumference of the housing engages, wherein a rolling bearing is arranged between each shoulder and the annular projection.

9. The rotary bearing according to claim 8, wherein the shoulders and the annular projection have conical surfaces arranged coaxially to one another, wherein an angular contact needle bearing is arranged between the conical surface of each shoulder and the conical surface of the annular projection facing this conical surface, wherein a preload of the angular contact needle bearings is adjustable by a screw position of the sleeves screwed together.

10. The rotary bearing according to claim 6, the second stops are formed by a shorter stop and by a longer stop, which extend to different distances in the direction of the first stop, and the first stop of which optionally extends in the direction of the second stops to such an extent that the first stop in the direction of the second stops either overlaps both second stops for a positive stop in both directions of rotation or only the longer stop for a positive stop in both directions of rotation.
